(19) United States
(12) Patent Application Publication
(10) Pub. No.: US 2023/0009487 A1
(43) Pub. Date: Jan. 12, 2023

(54) HYDROGEN AND OXYGEN PRODUCTION FROM WATER USING WAVE RESONANCE

(71) Applicant: Myeong-Eun HWANG, Gyeonggi-do (KR)

(72) Inventors: Myeong-Eun HWANG, Gyeonggi-do (KR); Do KIM, Santa Cruz, CA (US)

(73) Assignee: Myeong-Eun HWANG

(21) Appl. No.: 17/369,030

(22) Filed: Jul. 7, 2021

(51) Int. Cl. C01B 3/04; C25B 1/04; C25B 15/08; C25B 9/19

(52) U.S. Cl. CPC C01B 3/042; C25B 1/04; C25B 15/08; C25B 9/19; C01B 2203/0855

(57) ABSTRACT

Disclosed herein is a method and apparatus for producing hydrogen and oxygen from water, more particularly, for decomposing water molecular bonds using resonant waves. The produced hydrogen gas may be used as a fuel, and the released oxygen gas may be used as an oxidant.

### FIELD

The present disclosure relates to the field of producing hydrogen and oxygen gas, and their collection or separation for other uses, and in particular to an apparatus and method for exploiting the resonant effects of subharmonic and harmonic electromagnetic waves in conjunction with conventional methods of hydrogen production such as water electrolysis within a shielded and grounded enclosure supplied with water.

The energy density per unit volume of liquid and compressed hydrogen gas at practical pressures is less than that of traditional fuel sources, but the energy density per unit mass of hydrogen fuel is higher. Nevertheless, elemental hydrogen has been widely discussed in the context of energy on an industrial scale. Fuel cells can convert hydrogen and oxygen directly to electricity more efficiently than internal combustion engines.

The uses of the present disclosure are numerous. Examples may include fuel cell generators, fuel cell vehicles, improved combustion in fuel carbureting of gasoline and diesel engines, increased fuel consumption per gallon of gasoline and diesel engines, and the like.

### BACKGROUND

Hydrogen in its natural state exists in various types of compounds by combining with other elements. Conventional methods for separating pure hydrogen from a compound, such as steam reforming, pyrolysis, and water electrolysis, are used.

Steam reforming extracts hydrogen contained in water by reacting a hydrocarbon compound such as natural gas with steam, and has the advantages of low carbon dioxide production rate and obtaining a large amount of hydrogen from a certain amount of hydrocarbon compound, but the process temperature is near 950° C. or higher. Therefore, the process has the disadvantage of consuming a lot of energy.

Pyrolysis is a method of separating hydrogen by decomposing natural gas at a high temperature. Pyrolysis has advantages such as producing hydrogen without carbon dioxide and obtaining high-purity carbon black as a by-product, but because the reaction temperature is high, a high-temperature valve must be used and the reactor control is complicated.

Water electrolysis is a hydrogen production method known for a long time and has the advantage of being highly reliable and easy to obtain high-purity hydrogen, but it has the disadvantage of high production cost due to low energy efficiency and current density, and corrosion resistance to prevent corrosion of equipment by electrolyte.

Accordingly, there has been a need for a new type of hydrogen production method capable of producing a large amount of high-purity hydrogen at a low cost while compensating for the disadvantages of the conventional hydrogen production methods.

### SUMMARY

At least one goal of the present disclosure is to use resonant wave energy to break ionic bonds inside and among water molecules so that hydrogen and oxygen gases can be produced and then collected for other uses.

Another goal of the present disclosure is to provide a means of producing hydrogen and oxygen from water that is more eco-friendly and cost-effective than other conventional processes.

Another goal of the present disclosure is to provide a hydrogen and oxygen production apparatus that can be made in multiple sizes for different applications.

Objects of the present disclosure are not limited to those mentioned above, and other goals not mentioned will be clearly understood by those skilled in the art from the following description.

A hydrogen and oxygen production apparatus, according to an embodiment of the present disclosure, for achieving the above goals, may include, for example, an enclosure or water tank for storing water therein, a wave generator generating at least one electromagnetic wave having at least one frequency applied to the water stored in the enclosure in at least one direction, and a control unit for determining the frequency of the electromagnetic wave generated by the wave generator.

The apparatus may further include a cathode and an anode for effective hydrogen and oxygen production.

According to an embodiment of the present disclosure, the control unit may control the wave generator to generate at least one electromagnetic wave associated with at least one of a frequency that corresponds to the natural vibration of an intramolecular covalent bond in the water stored in the enclosure, multiples of the frequency, and submultiples of the frequency.

According to an embodiment of the present disclosure, the control unit may control the wave generator to generate at least one electromagnetic wave associated with at least one of a frequency that corresponds to the natural vibration of an intermolecular hydrogen bond in the water within the enclosure, multiples of the frequency, and submultiples of the frequency.

According to an embodiment of the present disclosure, the control unit may control the wave generator to generate at least one electromagnetic wave associated with at least one of a frequency that corresponds to an intermediate value between the natural vibration of the intramolecular covalent bond and the natural vibration of the intermolecular hydrogen bond of the water within the water enclosure, multiples of the frequency, and submultiples of the frequency.

According to an embodiment of the present disclosure, pure water, seawater, or water in which an electrolyte is dissolved may be used in the enclosure.

According to an embodiment of the present disclosure, the apparatus for producing hydrogen and oxygen may further comprise a cathode to which at least one negative electrode is electrically connected and an anode to which at least one positive electrode is electrically connected.

According to an embodiment of the present disclosure, the cathode and the anode are alternately arranged to face each other.

According to an embodiment of the present disclosure, the cathode and the anode may be arranged to contact the surface of the water within the enclosure.

According to an embodiment of the present disclosure, the cathode and the anode may be disposed to be deeply immersed in the water within the enclosure, and the control unit may apply a voltage equal to or greater than a reference value between the cathode and the anode so that water electrolysis occurs in the water within the enclosure.

According to an embodiment of the present disclosure, the wave generator may apply an electromagnetic wave to the water within the enclosure in a direction parallel to the cathode and the anode.

According to an embodiment of the present disclosure, the cathode and the anode may further include at least one membrane or separator in between each of them.

According to an embodiment of the present disclosure, the cathode and the anode may each have at least one hole, and the wave generator may generate an electromagnetic wave passing through the hole.

According to an embodiment of the present disclosure, the apparatus for producing hydrogen and oxygen may include a housing external to at least one of the cathode and the anode in order to separately collect at least one of hydrogen and oxygen generated at the cathode and the anode, respectively.

According to an embodiment of the present disclosure, the apparatus for producing hydrogen and oxygen may further comprise a magnet disposed adjacent to the water stored in the enclosure.

According to another embodiment of the present disclosure, the apparatus for producing hydrogen and oxygen may further comprise a water pipe and an injection nozzle in the enclosure.

According to the above-described hydrogen and oxygen production apparatus, it is possible to generate hydrogen and oxygen from water at low cost and high efficiency, and it is possible to achieve the effect of implementing a hydrogen and oxygen production apparatus in various sizes and shapes according to the purpose.

Effects of the present disclosure are not limited to the effects mentioned above, and other effects not mentioned will be clearly understood by those skilled in the art from the description of the claims.

### BRIEF DESCRIPTION OF THE DRAWINGS

FIG. 1 is a functional block diagram illustrating a hydrogen and oxygen production apparatus according to an embodiment of the present disclosure.

FIG. 2 is an illustration of a procedure for decomposing water molecules into hydrogen ions and oxygen ions according to an embodiment of the present disclosure.

FIG. 3 is an illustration of an electrode arrangement of an apparatus for producing hydrogen and oxygen according to an embodiment of the present disclosure.

FIG. 4 is an illustration of an electrode arrangement of an apparatus for producing hydrogen and oxygen according to another embodiment of the present disclosure.

FIG. 5 is a view for explaining a method of generating hydrogen and oxygen using both a resonant electromagnetic wave and a magnetic field according to an embodiment of the present disclosure.

FIG. 6 is a view for explaining a method of generating hydrogen and oxygen using both a resonant electromagnetic wave and electrolysis according to another embodiment of the present disclosure.

FIG. 7 is an illustration of generating hydrogen and oxygen by using both a resonant electromagnetic wave and electrolysis, and further using a separation membrane according to an embodiment of the present disclosure.

FIG. 8 is an illustration of an electrode arrangement of an apparatus for producing hydrogen and oxygen according to another embodiment of the present disclosure.

FIG. 9 is an illustration of the shape of the cathode and the anode according to another embodiment of the present disclosure.

FIG. 10 is a view for explaining a method for collecting hydrogen and oxygen generated at the cathode and the anode according to an embodiment of the present disclosure.

FIG. 11 is a view for explaining a method for increasing hydrogen and oxygen generation efficiency by spraying water in the form of mist according to another embodiment of the present disclosure.

FIG. 12 is a view for explaining an injection nozzle according to an embodiment of the present disclosure.

### DETAILED DESCRIPTION

Hereinafter, embodiments of the present disclosure will be described in detail with reference to the accompanying drawings. However, the accompanying drawings are only described in order to more easily disclose the contents of the present disclosure, the embodiments are merely described below, by referring to the figures, to explain aspects of the present description, and the scope of the present disclosure is not limited to the scope of the accompanying drawings.

Further, in describing the embodiment of the present disclosure, the same name and the same reference numeral are used for the components having the same function, but substantially not completely the same as the components of the prior art.

In addition, the terms used in the present disclosure are only used to describe specific embodiments, and are not intended to limit the present disclosure. The singular expression includes the meaning of the plural unless the context clearly dictates otherwise. In the present disclosure, terms such as “comprise”, “include”, or “have” are intended to designate that a feature, number, step, operation, component, part, or a combination thereof described in the specification exists, and one or more other features, for example, the cathodes (110-1, 110-2, 110-3, 110-4, . . . , 110-i) and the anodes (130-1, 130-2, 130-3, 130-4, . . . , 130-j), or numbers, steps, operations, components, parts, or the presence or the additional possibility of a combination are to be understood as not being precluded in advance.

In the present disclosure, an electromagnetic wave means a wave that vibrates periodically, and refers to a frequency domain resonating with the covalent bond and the hydrogen bond in water.

Hereinafter, a water-splitting apparatus according to an exemplary embodiment of the present disclosure will be described with reference to the accompanying drawings.

FIG. 1 is a functional block diagram for explaining an apparatus 100 for producing hydrogen and oxygen according to an embodiment of the present disclosure.

The hydrogen and oxygen production apparatus 100 according to an embodiment of the present disclosure includes an enclosure 150, a wave generator 170, and a control unit 190 as example components to decompose water into hydrogen and oxygen. A cathode 110 and an anode 130 may be further included as example components to effectively convert, separate, and collect hydrogen and oxygen. FIG. 1 only shows components related to the embodiment of the present disclosure, and of course, other components may be further included in addition to the components shown in FIG. 1 in implementing the present disclosure.

The cathode 110 is composed of at least one negative electrode, and the anode 130 is composed of at least one positive electrode. The cathode 110 and the anode 130 according to an embodiment of the present disclosure may be made of a metallic material.

Hydrogen ions, which are positive ions, are attached to the surface of the cathode 110 by electrical attraction. The hydrogen ions are absorbed to the cathode 110 as hydrogen atoms while obtaining electrons from the cathode 110 (Volmer reaction).

Then, a reaction between one hydrogen atom adsorbed on the surface of the cathode 110 and a hydrogen ion present in the water within the enclosure 150 (Heyrovsky reaction), or the bonding of two adsorbed hydrogen atoms (Tafel reaction) produces hydrogen gas.

The apparatus 100 for generating hydrogen and oxygen according to an embodiment of the present disclosure may further include a device for collecting hydrogen gas produced at the cathode 110.

Oxygen ions, which are negative ions, are attached to the surface of the anode 130 by electrical attraction. At the anode 130, in contrast to the cathode 110, an oxidation reaction occurs in which oxygen ions donate electrons to become oxygen gas. Similarly, the anode 130 may be further equipped with a device for collecting the produced oxygen gas therein.

A configuration for collecting the hydrogen gas generated at the cathode 110 and the oxygen gas generated at the anode 130 will be described in detail below.

The enclosure or water tank 150 may store pure water, tap water, seawater, or water in which electrolyte is dissolved according to a method of producing hydrogen and oxygen.

The wave generator 170 generates at least one electromagnetic wave having at least one frequency (e.g., a predetermined frequency). The electromagnetic wave is applied to the water inside the enclosure 150 in one or more directions.

The wave generator 170 induces resonance of water molecules in the water by applying electromagnetic waves to the water within the enclosure 150. Specifically, when an electromagnetic wave is applied to the inside of the enclosure 150 and collides with water molecules therein, the wave energy of the electromagnetic wave is absorbed by the water molecules. Probabilistically, water molecules on the water surface may have fewer hydrogen bonds than other water molecules in the water. Therefore, applying electromagnetic waves to the water surface and beneath the water surface may be more effective for hydrogen and oxygen production.

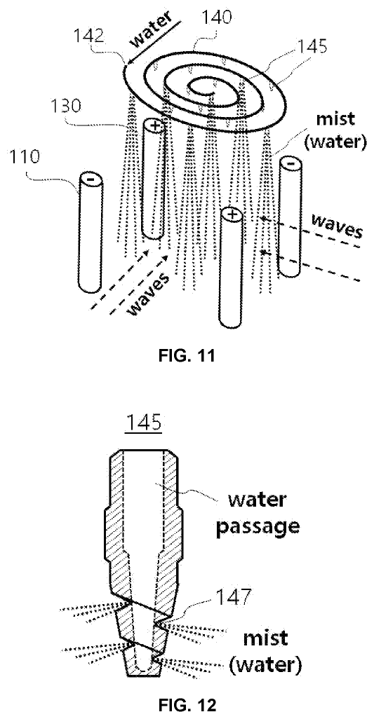

A way to effectively increase water surface area exposed to resonant electromagnetic waves by using water drops or mist form will be described in detail with reference to FIG. 11.

A water molecule that absorbs the wave energy of an electromagnetic wave experiences vibration. At this time, when the frequency of the electromagnetic wave absorbed by the water molecule, e.g., the frequency of the electromagnetic wave, matches the natural vibration or frequency of the water molecule, resonance occurs. Here, the natural or fundamental frequency is a concept encompassing both the natural frequency, oscillation, fluctuation, or vibration of a hydrogen bond between water molecules and the natural frequency, oscillation, fluctuation, or vibration of a covalent bond between oxygen-hydrogen atoms in water.

When resonance occurs, the amplitude of the vibration increases rapidly, reaching an energy level sufficient to break the covalent and hydrogen bonds of water molecules. Eventually, intramolecular covalent bonds and intermolecular hydrogen bonds in the water within the enclosure 150 are broken and the water molecules are decomposed into positively charged hydrogen ions and negatively charged oxygen ions, respectively.

The control unit 190 may control the overall operation of the hydrogen and oxygen production apparatus 100. For example, the control unit 190 determines a frequency of the electromagnetic wave generated by the wave generator 170, and a predetermined voltage applied so that the cathode 110 and the anode 130 each have their electrical polarity.

A detailed control operation of the control unit 190 will be described in detail below.

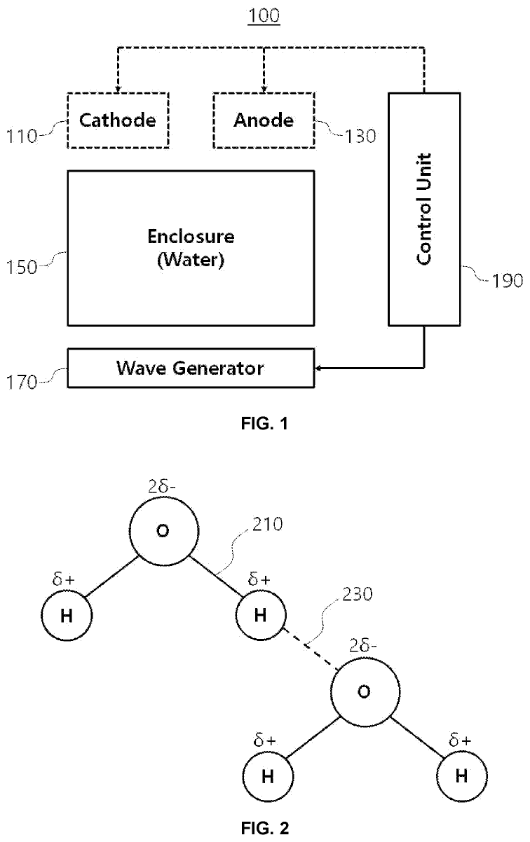

FIG. 2 is a view for explaining a procedure for decomposing a water molecule into hydrogen ions and oxygen ion according to an embodiment of the present disclosure.

There are two major types of ionic bonds in water: intramolecular and intermolecular bonds. In modern electrochemistry, the intramolecular bond is known as the covalent or the O—H bond while the intermolecular bond is the hydrogen bond or the H—OH bond. All water molecules have covalent bonds, but only some water molecules have hydrogen bonds in the liquid-form water. Their bonding energies are slightly different to each other: the O—H bonding energy is 428 kJ/mol in average whereas the H—OH bonding energy is 498.7 kJ/mol, where the bonding energy is the amount of energy to dissociate its corresponding bond, and mol is the symbol of the mole which is the unit of measurement for amount of substance, defined as about 6.02×10²³ particles. The fundamental frequencies of the electromagnetic waves associated with these bonding energies are about 1.07 PHz and 1.25 PHz, respectively.

In the embodiment of FIG. 2, a water molecule includes a covalent bond 210 formed by each of a hydrogen atom and an oxygen atom donating an electron to make an electron pair and sharing the pair together.

On the other hand, in the covalent bond 210 between oxygen and hydrogen within the water molecule, due to the difference in electronegativity between oxygen and hydrogen, the atomic nucleus of oxygen attracts an electron pair stronger than the atomic nucleus of hydrogen, so that the shared electron pair is closer to and more likely to stay on the oxygen atom compared to the hydrogen atom.

For the reasons mentioned above, the oxygen atom of the water molecule is partially negatively charged (2δ−) and each hydrogen atom is partially positively charged (δ+). Due to the difference in polarity, hydrogen bonds 230 among water molecules are formed.

Therefore, in order to decompose water molecules to obtain hydrogen ions and oxygen ions, not only the covalent bond 210 inside the water molecule but also the hydrogen bond 230 among the water molecules must be broken.

The bond dissociation energy for breaking the covalent bond 210 inside the water molecule is 428 kJ/mol, and the bond dissociation energy for breaking the hydrogen bond 230 between the water molecules is 498.7 kJ/mol, and both bonds require very high energy for dissociation.

On the other hand, the natural frequency of the covalent bond 210 is 1.07 PHz, and the natural frequency of the hydrogen bond 230 is 1.25 PHz. Therefore, when an electromagnetic wave having a frequency of 1.07 PHz is applied from the outside, resonance occurs in the covalent bond 210, so that the covalent bond 210 is broken even if an energy corresponding to the above-described bond dissociation energy is not applied in another way. Similarly, when an electromagnetic wave having a frequency of about 1.25 PHz is applied from the outside, resonance may occur in the hydrogen bond 230, so that even if an energy corresponding to the bond dissociation energy of the hydrogen bond 230 is not applied in another way, the hydrogen bond 230 may be cut off. However, electromagnetic waves having these two frequencies are not necessarily required to separate water molecules into oxygen and hydrogen. Resonance may occur even when an electromagnetic wave of a frequency adjacent to the natural frequency or a frequency between the natural frequency of the covalent bond 210 and the natural frequency of the hydrogen bond 230 is applied. For example, when an electromagnetic wave having about 1.16 PHz applied, resonance may occur in both the intramolecular covalent bond 210 and the intermolecular hydrogen bond 230.

Accordingly, the wave generator 170, according to an embodiment of the present disclosure, generates at least one electromagnetic wave associated with the natural frequency that corresponds to the natural vibration of the covalent bond 210 in the water within the enclosure 150.

The wave generator 170, according to another embodiment of the present disclosure, generates at least one electromagnetic wave associated with the natural frequency that corresponds to the natural vibration of the hydrogen bond 230 in the water within the enclosure 150.

The wave generator 170, according to another embodiment of the present disclosure, generates at least one electromagnetic wave associated with a frequency that corresponds to an intermediate value between the natural vibration of the covalent bond 210 and the natural vibration of the hydrogen bond 230 in the water within the enclosure 150.

Alternatively, the control unit 190, according to an embodiment of the present disclosure, may control the wave generator 170 to generate at least one electromagnetic wave having at least one of a frequency corresponding to the natural vibration of the covalent bond 210, a frequency corresponding to the natural vibration of the hydrogen bond 230, and a frequency corresponding to an intermediate value between the natural vibration of the covalent bond 210 and the natural vibration of the hydrogen bond 230 in the water within the enclosure 150.

To this end, the wave generator 170, according to an embodiment of the present disclosure, may be implemented as at least one of several types of wave generators such as a function generator, a radio frequency and microwave signal generator, a pitch generator, an arbitrary waveform generator, a digital pattern generator, a frequency generator, etc.

Meanwhile, resonance does not occur only when an electromagnetic wave having the same frequency as the natural vibration of the covalent bond 210 or the hydrogen bond 230 is applied. For example, resonance may be induced to occur when harmonic waves or harmonics (e.g., multiples of a frequency corresponding to the natural vibration of a system) are applied. Also, resonance may be induced to occur when some subharmonic waves or subharmonics (e.g., fractional frequency components or submultiples of a frequency corresponding to the natural vibration of a system) are applied.

Therefore, the control unit 190, according to another embodiment of the present disclosure, controls the wave generator 170 to generate at least one electromagnetic wave having at least one multiple of the natural frequency of the covalent bond 210, or at least one submultiple of the natural frequency of the covalent bond 210 in the water within the enclosure 150.

The control unit 190, according to another embodiment of the present disclosure, controls the wave generator 170 to generate at least one electromagnetic wave having at least one multiple of the natural frequency of the hydrogen bond 230, or at least one submultiple of the natural frequency of the hydrogen bond 230 in the water within the enclosure 150.

The control unit 190, according to another embodiment of the present disclosure, controls the wave generator 170 to generate at least one electromagnetic wave having at least one multiple of an intermediate value between the natural frequency of the covalent bond 210 and the natural frequency of the hydrogen bond 230, or at least one submultiple of an intermediate value between the natural frequency of the covalent bond 210 and the natural frequency of the hydrogen bond 230 in the water within the enclosure 150.

According to the method described above, it is possible to obtain the effect of inducing resonance of water molecules without generating an electromagnetic wave having an excessively high frequency.

Meanwhile, the oxygen-hydrogen bonding energy inside a water molecule, the bonding energy between the water molecules, and their average bonding energy may vary depending on ambient conditions or the density of the electrolyte dissolved in water. Accordingly, the control unit 190, according to an embodiment of the present disclosure, may perform at least one of frequency division, frequency mixing, frequency multiplication, and frequency sweeping to select an optimal frequency capable of resonating water molecules within a predetermined frequency range.

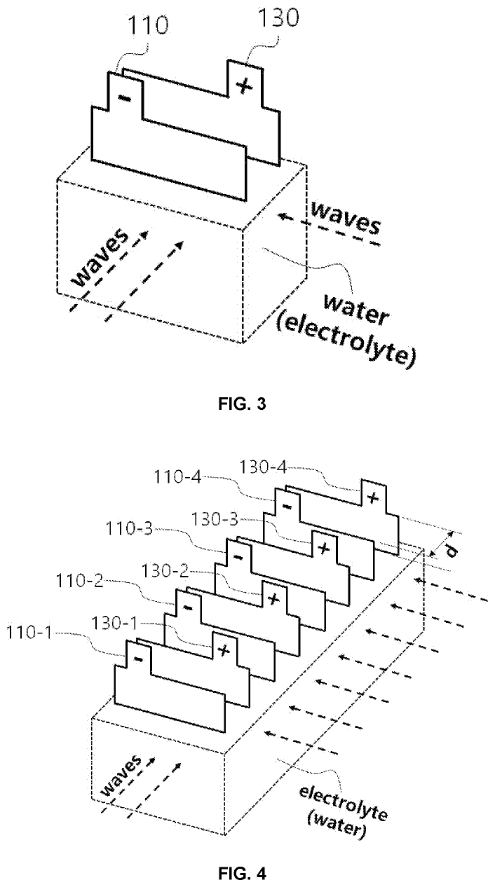

FIG. 3 is a view for explaining an electrode arrangement of the apparatus 100 for producing hydrogen and oxygen according to an embodiment of the present disclosure.

The cathode 110 and the anode 130 according to an embodiment of the present disclosure may be disposed to contact the surface of the water or to be partially immersed in the water within the enclosure 150.

At this time, the wave generator 170 may be deployed to apply an electromagnetic wave to the water inside the enclosure 150 in any direction. Alternatively, the wave generator 170 may be deployed to apply at least one electromagnetic wave to the water inside the water enclosure 150 in at least one direction.

When an electromagnetic wave incident from the wave generator 170 reaches water molecules or atoms, the wave energy of the electromagnetic wave is absorbed by the water molecule. The absorbed wave energy causes resonance to break not only the hydrogen bonds among water molecules but also the oxygen-hydrogen covalent bonds inside the water molecules.

When the covalent bond 210 and the hydrogen bond 230 of the water molecule are broken, a hydrogen ion that is a cation and an oxygen ion that is an anion are generated. The cathode 110 and the anode 130 have different electric potentials to each other. Due to an electrical force or an electric field developed between the electrodes of the cathode 110 and the anode 130, the hydrogen ions and the oxygen ions become attracted to the cathode 110 and the anode 130, respectively, and converted thereto into hydrogen gas and oxygen gas, respectively.

A process in which the cathode 110 and the anode 130 supply negative and positive charges to hydrogen ions and oxygen ions, respectively, and a process in which the hydrogen and oxygen ions are converted into their gaseous states have been described in detail with reference to FIG. 1, so here a duplicate description is omitted.

Meanwhile, the arrangement of the cathode 110 and the anode 130 is not limited to that shown in FIG. 3 and may be arranged in various ways or shapes.

FIG. 4 is a view for explaining an electrode arrangement of the apparatus 100 for producing hydrogen and oxygen according to another embodiment of the present disclosure.

According to another embodiment of the present disclosure, a plurality of cathodes 110-1, 110-2, 110-3, 110-4, . . . , 110-i and a plurality of anodes 130-1, 130-2, 130-3, 130-4, . . . , 130-j may be alternately arranged in a form facing each other.

As shown in FIG. 3, a plurality of cathodes and a plurality of anodes may be arranged to contact the surface of the water or to be partially immersed in the water within the enclosure 150.

In FIG. 4, a plurality of cathodes 110-1, 110-2, 110-3, 110-4, . . . , 110-i and a plurality of anodes 130-1, 130-2, 130-3, 130-4, . . . , 130-j are arranged to produce more hydrogen gas and oxygen gas generated by the dissociation of water molecules.

At the cathodes 110, hydrogen ions are reduced to generate hydrogen gas, and at the anodes 130, oxygen ions are oxidized to generate oxygen gas. The more pairs of cathode and anode electrodes, the more hydrogen gas and oxygen gas generated.

Accordingly, the number of the cathode electrodes and the anode electrodes may be appropriately adjusted according to the use and purpose of the hydrogen and oxygen production apparatus 100.

The arrangement of the cathodes 110 and the anodes 130 is not limited to that shown in FIG. 4 and may be disposed in various shapes or ways.

Meanwhile, in the above example, generation of hydrogen gas and oxygen gas from water molecules using resonant electromagnetic waves has been described as an example, but at least one of magnetic field induction and electrolysis may be performed in parallel with resonant electromagnetic waves for more efficient hydrogen and oxygen production.

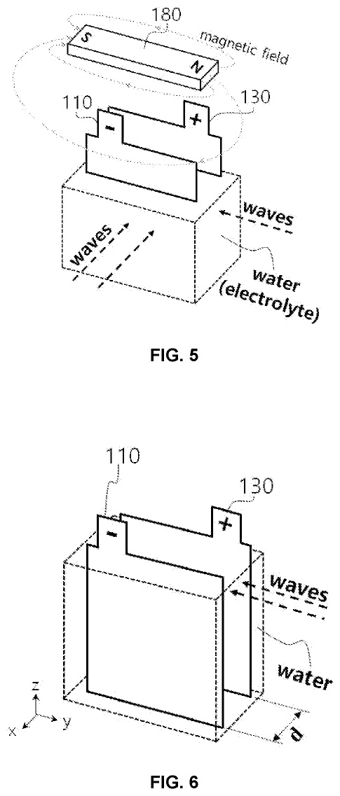

FIG. 5 is a view for explaining a method of generating hydrogen and oxygen using both a resonant electromagnetic wave and a magnetic field according to an embodiment of the present disclosure.

The hydrogen and oxygen production apparatus 100, according to an embodiment of the present disclosure, may further include a magnet 180 disposed adjacent to the water within the enclosure 150.

Just as electrons spin, so do some nuclei (e.g., protons). The nucleus actually rotates round that axis of the nuclear spin (known as precession), which causes the atomic nucleus to have small magnetic properties.

In the absence of an external magnetic field, the nuclear spin, or more precisely, the precession axis of the nuclear spin, is randomly aligned. When a magnetic field is applied from the outside, an induced magnetic field is generated, in which the nuclear spins are aligned in the same or opposite direction to the external magnetic field.

The proton, the nucleus of the hydrogen atom in water, has a spin in an arbitrary direction. Therefore, when placed in a strong magnetic field, the spin direction of the nuclei of hydrogen atoms is aligned along the direction of the magnetic field, which causes the hydrogen-containing water molecules to align with the direction of the externally applied magnetic field (even if some water molecules may align in the opposite direction of the external magnetic field). If an electromagnetic wave is applied in the vertical direction in this state, water molecules will be able to more effectively absorb the energy of electromagnetic waves.

In particular, since the water molecules on the surface of the water are limited by one-dimension in terms of the spatial freedom of movement, the direction in which an electromagnetic wave is applied can be determined so that the energy of the electromagnetic wave can be absorbed more effectively.

Permanent magnets, such as neodymium magnets, create a magnetic field around them. And, the electromagnets induce a magnetic field while current flows in the conducting wire. In order to generate a magnetic field applied from the outside, an electromagnet or a permanent magnet may be used.

FIG. 6 is an illustration for explaining a method of generating hydrogen and oxygen using both resonant electromagnetic waves and electrolysis according to an embodiment of the present disclosure.

In the apparatus 100 for producing hydrogen and oxygen, according to an embodiment of the present disclosure, electromagnetic waves having at least one frequency output from the wave generator 170 are applied to the water within the enclosure 150, and at the same time the cathode 110 and the anode 130 may allow electrolysis to proceed in the water within the enclosure 150.

For this purpose, since generation of hydrogen and oxygen by electrolysis is made on the surfaces of the cathode 110 and the anode 130, when electrolysis is performed together with resonant electromagnetic waves, the cathode 110 and the anode 130 are placed to be deeply submerged in water.

In addition, since electricity may not flow well in pure water, an electrolyte may be dissolved in the water within the enclosure 150.

The control unit 190 is coupled to the cathode 110 and the anode 130, and may apply a voltage equal to or greater than a reference value between the negative and positive electrodes so that water electrolysis occurs in the water within the enclosure 150. Preferably, the control unit 190, according to an embodiment of the present disclosure, may determine a voltage so that the electric potential difference between the cathode 110 and the anode 130 is equal to or greater than the standard reduction potential of hydrogen of 1.23 V.

When the cathode 110 and the anode 130 are disposed to be immersed in the water stored in the enclosure 150, the wave generator 170 emits electromagnetic waves having at least one frequency (e.g., a predetermined frequency) to the water in a direction parallel to the plate-shaped cathode 110 and anode 130 (for example, in the y-axis or z-axis direction of FIG. 6).

This is because when an electromagnetic wave generated by the wave generator 170 is applied to the water inside the enclosure 150 in a direction perpendicular to the cathode 110 and the anode 130, the electromagnetic wave may be impeded by the plates made of metallic material and the absorption efficiency of the electromagnetic wave decreases.

For example, when an electromagnetic wave is applied in a direction along the x-axis direction shown in FIG. 6, the electromagnetic wave is reflected or shielded by a metallic plate-shaped cathode and/or anode to reach only a portion of the water within the water enclosure 150.

Therefore, the wave generator 170 according to an embodiment of the present disclosure applies an electromagnetic wave to the water within the water enclosure 150 in a direction parallel to the plate-shaped cathode 110 and anode 130 (or along at least one of the z-axis and y-axis directions shown in FIG. 6)

As described above, hydrogen and oxygen generation by electromagnetic wave resonance combined with electrolysis can achieve the effect of further increasing the hydrogen and oxygen production rate and efficiency.

In addition, when hydrogen and oxygen generation by resonant electromagnetic waves is performed in conjunction with generation of hydrogen and oxygen by at least one of magnetic field induction and water electrolysis, the cathode 110 and the anode 130 may, of course, be implemented in a form in which they are alternately and repeatedly disposed.

Meanwhile, as the electric potential difference between the cathode electrode and the anode electrode increases, the strength of an electric field generated between the two electrodes becomes stronger, thereby the generated hydrogen ions and oxygen ions are strongly attracted to the electrodes, respectively and separately.

Alternatively, as the distance between the two electrodes (indicated by “d” in FIG. 6) becomes narrower, the strength of the electric field generated in between the two electrodes also becomes stronger, so that the generated hydrogen ions and oxygen ions are pulled harder to the electrodes, respectively and separately.

In extreme cases, such as nanogap electrochemical cells, when the distance between the cathode electrode 110 and the anode electrode 130 becomes as narrow as the Debye length (e.g., 37 nanometers), a very powerful and uniform electric field formed in between the two electrodes can lead to a reaction close to the breakdown of water molecules and further enhance ion-migration in the bulk solution, thereby increasing the overall reaction rate of the reactants.

This virtual breakdown of water molecules is also affected by the surrounding environment, such as the electric potential difference between the two electrodes, the electrolyte concentration, temperature, pressure, etc. Therefore, the use of water in which the electrolyte is dissolved can facilitate this reaction even with a less narrow gap between the two electrodes.

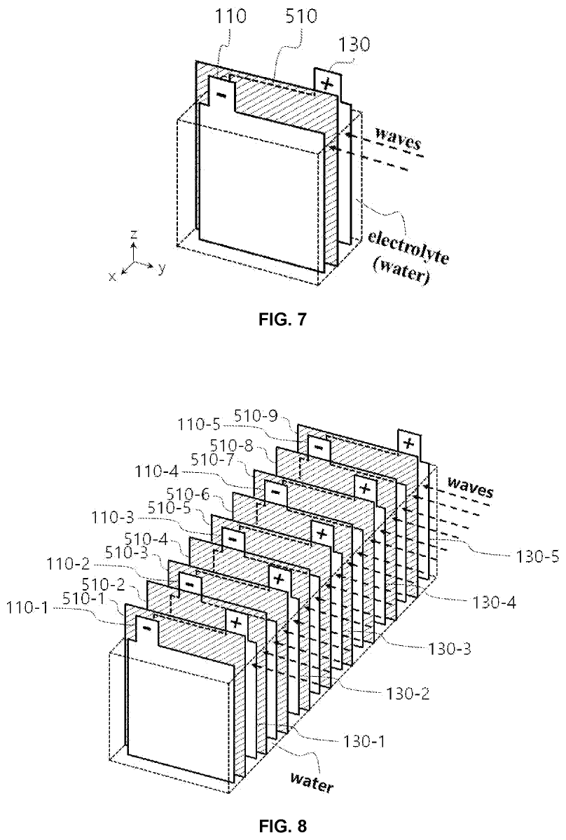

FIG. 7 is a view for explaining a method of producing hydrogen and oxygen using both resonant electromagnetic waves and water electrolysis with a membrane according to another embodiment of the present disclosure.

As shown in FIG. 6, the apparatus 100 for producing hydrogen and oxygen shown in FIG. 7 may allow an electromagnetic wave having a predetermined frequency output from the wave generator 170 to be applied to the water, and at the same time to perform water electrolysis in the water within the enclosure 150.

To this end, the apparatus 100 according to an embodiment of the present disclosure may further include a membrane or separator 510 disposed between the cathode 110 and the anode 130.

The membrane 510 according to an embodiment of the present disclosure may be implemented as a polyelectrolyte membrane, a proton exchange membrane, etc. according to an electrolysis method, but is not limited thereto. Here, the membrane 510 prevents mixing of generated hydrogen and oxygen gases and electrically separates the cathode 110 from the anode 130.

Additionally, since the generation of hydrogen and oxygen by electrolysis is made on the surfaces of the cathode 110 and the anode 130, when the water electrolysis is performed together with the application of electromagnetic waves, the cathode 110 and the anode 130 are disposed in such a way that they are deeply immersed in the water within the enclosure 150.

The control unit 190 may apply a voltage equal to or greater than a reference value between the negative and positive electrodes so that water electrolysis occurs in the water within the enclosure 150. Preferably, the control unit 190, according to an embodiment of the present disclosure, may determine a voltage so that the electric potential difference between the cathode 110 and the anode 130 is equal to or greater than the standard reduction potential of hydrogen of 1.23 V.

When the cathode 110 and the anode 130 are disposed to be immersed in water, the wave generator 170 according to an embodiment of the present emits electromagnetic waves having at least one predetermined frequency to the water within the water enclosure 150 in a direction parallel to the plate-shaped cathode 110 and anode 130.

For example, when an electromagnetic wave is applied in a direction along the x-axis direction shown in FIG. 7, the electromagnetic wave is reflected or shielded by a metallic negative or positive electrode plate to reach only a portion of the water stored in the water enclosure 150.

Therefore, the wave generator 170 according to an embodiment of the present disclosure applies an electromagnetic wave to the water within the enclosure 150 in a direction parallel to the plate-shaped cathode 110 and anode 130 (or along the y-axis or y-axis direction shown in FIG. 7).

As described above, hydrogen and oxygen generation by electromagnetic wave resonance combined with electrolysis can achieve the effect of further increasing the hydrogen and oxygen production rate and efficiency.

FIG. 8 is an illustration of an electrode arrangement of the hydrogen and oxygen production apparatus 100 using both resonant electromagnetic waves and water electrolysis with a membrane according to another embodiment of the present disclosure.

According to an embodiment of the present disclosure, a plurality of cathodes 110-1, 110-2, 110-3, 110-4, . . . , 110-i, a plurality of membranes 510-1, 510-2, 510-3, 510-4, . . . , 510-k, and a plurality of anodes 130-1, 130-2, 130-3, 130-4, . . . , 130-j may be repeatedly arranged in a successive order of cathode 110—membrane 510—anode 130—membrane 510.

As shown in FIG. 8, the use of a plurality of cathodes 110, anodes 130, and membranes 510 can achieve the effect of producing a larger amount of hydrogen and oxygen with both resonant electromagnetic waves and water electrolysis.

Meanwhile, even in the embodiment shown in FIG. 8, the wave generator 170 applies electromagnetic waves to the water within the enclosure 150 in a direction parallel to the plate-shaped cathode 110 and anode 130. In this case, at least one electromagnetic wave may be applied in at least one direction parallel to the plate-shaped cathode 110 and anode 130.

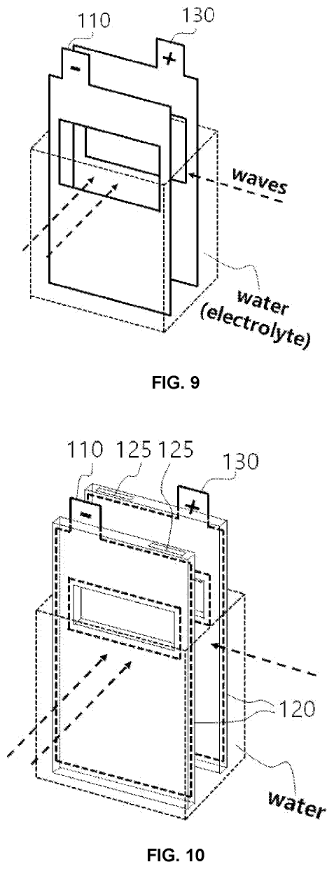

FIG. 9 is a view for explaining the shape of the cathode 110 and the anode 130 according to an embodiment of the present disclosure.

The cathode 110 and the anode 130, according to an embodiment of the present disclosure, are plate-shaped metal and include at least one hole. Here, the hole means an empty portion or part formed in the plate-shaped cathode 110 and anode 130.

As shown in FIG. 7 and FIG. 8, the plate-shaped cathode 110 and the plate-shaped anode 130 may shield or reflect electromagnetic waves incident in a certain direction (e.g., a direction perpendicular to the electrode plates), so that electromagnetic waves may reach only the water in some region, and resonance of water molecules occurs only in other limited region of the water in the enclosure 150.

For example, electromagnetic waves incident in a direction orthogonal to the plate-shaped cathode 110 and anode 130 are shielded by the cathode 110 and the anode 130 and the electromagnetic waves cannot reach the water molecules on the rear surfaces of the plate-shaped electrodes.

To this end, the cathode 110 and the anode 130 according to an embodiment of the present disclosure each include at least one hole. At this time, the wave generator 170 may generate electromagnetic waves orthogonal to the cathode 110 and the anode 130 passing through the holes and thus reaching the water bulk within the enclosure 150.

However, the shape and number of the holes included in the cathode 110 and the anode 130 are not limited to those shown in FIG. 9, and multiple holes of various shapes may be formed in a plurality of areas.

Meanwhile, the cathode 110 and the anode 130 shown in FIG. 9 can be implemented in a form in which a plurality of negative electrodes and a plurality of positive electrodes are alternately and repeatedly disposed as shown in FIGS. 4 and 8.

In addition, when producing hydrogen and oxygen by both electromagnetic wave resonance and electrolysis with membranes, of course the electrodes and the membranes may be repeatedly arranged in a successive order of cathode 110—membrane 510—anode 130—membrane 510.

FIG. 10 is an illustration of a method for collecting hydrogen and oxygen gases generated at the cathode and the anode, respectively, according to an embodiment of the present disclosure.

A housing 120 for collecting hydrogen gas generated at the cathode 110 is provided outside the cathode 110 according to an embodiment of the present disclosure. According to an embodiment of the present disclosure, hydrogen gas generated at the cathode 110 is collected inside the housing 120.

The hydrogen gas collected inside the housing 120 may be discharged to the outside through an opening 125 formed at the top of the housing 120, and then stored in a separate storage.

The anode 130 may also be equipped with a housing 120 on the outside of the anode 130 like the cathode 110, and the oxygen gas collected inside the housing 120 may be discharged to the outside through an opening 125 formed at the top of the housing 120, and then stored in another separate storage.

Meanwhile, when the housing 120 surrounds all of the cathode 110 or the anode 130, the electrode cannot come into contact with the water stored in the water enclosure 150, so the lower end of the housing 120 may be open.

FIG. 11 is a view for explaining a method for increasing hydrogen and oxygen generation efficiency by increasing the surface area of water molecules using a water tube and an injection nozzle according to another embodiment of the present disclosure.

Probabilistically, water molecules existing on the water surface may have fewer hydrogen bonds than water molecules present inside water (or bulk), and may be more effectively dissociated by the wave energy of the applied electromagnetic wave.

Here, the wave generator 170 may be arranged to apply at least one electromagnetic wave to the water inside the enclosure 150 in at least one direction.

To this end, according to an embodiment of the present disclosure, the apparatus 100 for producing hydrogen and oxygen may further include a water pipe 140 positioned (e.g., installed, etc.) inside the enclosure 150. The water pipe 140 may have a water inlet 142 and at least one injection nozzle 145. Water is supplied to the water pipe 140 through the water inlet 142, and the injection nozzle 145 sprays the water supplied from the outside into the enclosure 150 in the form of mist or water droplets so that the water droplets in the mist form may be evenly distributed in the enclosure 150.

The cathode 110 and the anode 130 attract generated hydrogen ions and oxygen ions, respectively, and supply negative and positive charges to hydrogen ions and oxygen ions, respectively, and convert hydrogen ions and oxygen ions into their gaseous states, respectively. Since the process has been described in detail in FIG. 1, a redundant description is omitted.

FIG. 12 is a view for explaining an injection nozzle according to an embodiment of the present disclosure. The injection nozzle 145 is composed of a conical inner water passage, and the inner water passage is connected to at least one nozzle hole 147. The nozzle hole 147 may inject water supplied from the outside into the water tank 150 in the form of mist or water droplets having a uniform spray pattern in the shape of a spiral cone.

The injection nozzle 145 may provide an open passage ideal for use with water that may contain particulate matter, as is the case with the present disclosure.

Meanwhile, the arrangement of the water tube 140 is not limited to that shown in FIG. 11, and the number, location, and shape of the water tubes may be various depending on the applications. Of course, at least one water pipe 140 may be installed inside the enclosure 150, and disposed anywhere in the enclosure 150, including the side of the enclosure 150 with various shapes.

In addition, the structure of the injection nozzle 145 is not limited to that shown in FIG. 12, and may have various shapes, various numbers of the inner water passages, and at least one or more injection holes 147 at various positions along the inner water passage.

Embodiments according to the present disclosure are described above. The fact that the present disclosure can be embodied in other specific forms without departing from the intent or scope of the present disclosure may be evident to those skilled in the art. Therefore, the above-described embodiments are to be regarded as illustrative rather than restrictive, and accordingly, the present disclosure is not limited to the above description, but may be modified within the scope of the appended claims and their equivalents.

What is claimed is:

1. An apparatus for splitting water molecules into hydrogen and oxygen, the apparatus comprising:
an enclosure configured to store water;
a wave generator configured to generate at least one electromagnetic wave and apply the at least one electromagnetic wave to the water in at least one direction; and
a control unit in communication with the wave generator, and configured to determine a frequency of the electromagnetic wave generated by the wave generator.

2. The apparatus of claim 1, wherein the frequency of the electromagnetic wave corresponds to at least one of a natural vibration of a covalent bond in the water, subharmonics of the natural vibration, and harmonics of the natural vibration.

3. The apparatus of claim 1, wherein the frequency of the electromagnetic wave corresponds to at least one of a natural vibration of a hydrogen bond in the water, subharmonics of the natural vibration, and harmonics of the natural vibration.

4. The apparatus of claim 1, wherein the frequency of the electromagnetic wave corresponds to at least one of an intermediate value between a natural vibration of a covalent bond in the water and a natural vibration of a hydrogen bond in the water, subharmonics of the intermediate value, and harmonics of the intermediate value.

5. The apparatus of claim 1, further comprising:
at least one cathode to which at least one negative electrode is electrically connected; and
at least one anode to which at least one positive electrode is electrically connected.

6. The apparatus of claim 5, wherein:
the at least one cathode and the at least one anode are configured to be immersed in the water and alternately arranged each other; and
the control unit is configured to apply a voltage equal to or higher than a reference value between the at least one cathode and the at least one anode to induce water electrolysis.

7. The apparatus of claim 5, wherein the wave generator is configured to apply at least one electromagnetic wave to the water in a direction parallel to at least one of the cathode and the anode.

8. The apparatus of claim 6, further comprising a membrane disposed between the at least one anode and the at least one cathode.

9. The apparatus of claim 6, wherein:
at least one of the cathode and the anode defines at least one hole; and
the wave generator is configured to apply the electromagnetic wave to the water so that the electromagnetic wave passes through the at least one hole of the cathode and the anode.

10. The apparatus of claim 6, further comprising a housing configured to surround at least a portion of at least one of the cathode and the anode, wherein the housing is configured to collect hydrogen or oxygen gas generated therein.

11. The apparatus of claim 1, further comprising a magnet disposed adjacent to the water.

12. The apparatus of claim 1, further comprising at least one water pipe positioned within the enclosure, wherein the at least one water pipe includes at least one injection nozzle configured to spray water droplets in the form of a mist.
